(19) United States
(12) Patent Application Publication
(10) Pub. No.: US 2026/0006419 A1
(43) Pub. Date: Jan. 1, 2026

(54) METHODS OF MUTUALLY PAIRING A WIRELESS GEAR CONTROL DEVICE AND A WIRELESS GEAR CHANGING DEVICE FOR A BICYCLE, WIRELESS DEVICES, AND WIRELESS GEAR CHANGING SYSTEM

(71) Applicant: CLASSIFIED CYCLING BV, Antwerpen (BE)

(72) Inventor: Roëll Marie VAN DRUTEN, Eindhoven (NL)

(21) Appl. No.: 18/880,780

(22) PCT Filed: Jul. 6, 2023
(86) PCT No.: PCT/EP2023/068740

§ 371 Date: Jan. 2, 2025

(30) Foreign Application Priority Data
Jul. 7, 2022 (NL) 2032405

(51) Int. Cl. H04W 4/70; B62K 23/02; B62M 25/08

(52) U.S. Cl. CPC H04W 4/70; B62K 23/02; B62M 25/08

(57) ABSTRACT

Method of mutually pairing a wireless gear control device and a wireless gear changing device for a bicycle, comprising: providing a wireless gear control device and a wireless gear changing device for a bicycle; by a user action to at least one of the wireless devices, causing the at least one of the wireless devices to attempt to participate in a pairing process in which the wireless devices can be mutually paired; and completing the pairing process so as to mutually pair the wireless devices. Further aspects provide a corresponding wireless gear changing system, wireless devices for use in the system, and associated methods.

### FIELD

The invention concerns methods of mutually pairing a wireless gear control device and a wireless gear changing device for a bicycle, and further concerns a wireless gear changing system for a bicycle, a wireless gear control device and a wireless gear changing device.

### BACKGROUND

Wireless gear changing systems for bicycles are known as such for changing gears on a bicycle without use of a wired connection between a gear control device, usually arranged on a handle bar, and a gear changing device, usually arranged at a transmission such as a derailleur. A known wireless gear changing system comprises: a wireless gear control device comprising a respective wireless communication unit and configured to send a gear change message via its wireless communication unit; and a wireless gear changing device comprising a respective wireless communication unit and configured to effect a gear change in a bicycle depending on a gear change message received via its wireless communication unit, in particular from the wireless gear control device.

In the known system, both the wireless gear control device and the wireless gear changing device cannot easily be replaced, because both devices are specifically configured to communicate with the other device and not with any other device. The specific configurations are primarily intended to avoid accidental or malicious communication between devices which are not both legitimately associated with a same bicycle.

### SUMMARY

An object of the invention is to at least partly overcome at least one of the above problems or an associated problem, in particular while maintaining or enhancing existing advantages. An object is to improve usability of wireless gear changing systems for bicycles, in particular with respect to replacement and/or exchange of wireless devices thereof.

To that end, an aspect provides a method of mutually pairing a wireless gear control device and a wireless gear changing device for a bicycle.

The method comprises providing a wireless gear control device and a wireless gear changing device for a bicycle, wherein both wireless devices comprise a respective wireless communication unit. The wireless gear changing device is configured to effect a gear change in a bicycle, at least when mounted to the bicycle, depending on a gear change message received via its wireless communication unit. The wireless gear control device is configured to send a gear change message via its wireless communication unit. Optionally, the wireless gear control device is further configured to send and/or receive one or more other types of messages, e.g. to and/or from one or more sensors such as bicycle based sensors and/or body worn sensors.

The method further comprises: by a user action to at least one of the wireless devices, causing at least one of the wireless devices to attempt to participate in a pairing process in which the wireless devices can be mutually paired; and completing the pairing process so as to mutually pair the wireless devices.

Pairing processes for wireless devices are known as such in various forms and generally refer to processes in which the devices directly and/or indirectly exchange information so as to be able to automatically recognize each other for future mutual wireless communication. Once paired, the wireless devices can automatically recognize each other for mutual wireless communication. The wireless gear control device can be configured to not send a gear change message to a wireless gear changing device that is not paired to the wireless gear control device, and/or to not receive a gear change message from a wireless device that is not paired to the wireless gear control device. The wireless gear changing device can be configured to not effect a gear change in response to a gear change message sent by a to a wireless gear control device that is not paired to the wireless gear changing device. For the pairing process to be completed successfully, participation from both devices is usually required, preferably contemporaneously. Meanwhile, for reasons of security and power saving, it is usually desired that wireless devices only attempt to participate in such a pairing process if and when needed. It shall be appreciated that such attempting to participate can take various forms and may e.g. comprise scanning for other devices, sending a message to another device, listening for messages from another device, encrypting a message regarding the pairing process, decrypting a message regarding the pairing process, prompting a user regarding the pairing process and/or processing a user input regarding the pairing process. Whether or not the attempt to participate is successful may generally depend on the other device, e.g. whether it is within range for wireless communication and/or whether it is also attempting to participate in the pairing process. In some cases, active cooperation of the other device may not be necessary, for example when pairing information is exchanged between devices by a user instead.

Advantageously, by defining that the attempting to participate in a pairing process be caused by a user action to the respective device, the present pairing method enables easy and effective replacement and/or exchange of wireless devices of a wireless gear changing system, overcoming the inherent limitations of prior art systems in which respective pairs of devices are essentially fixed for life. Details of the user action, and corresponding configurations of the devices and/or the system, may be designed in various ways, as will be explained further herein.

The wireless communication between the wireless gear control device and the wireless gear changing device can e.g. comprise Bluetooth, Bluetooth Low Energy (BTLE), ANT, ANT+, Zigbee, 6LoWPAN, Thread, WiFi, WiFi-ah, or the like, such as 2.4 GHz communication.

Optionally, the wireless gear changing device is configured to be arranged within a hub for a bicycle wheel. Optionally, the wireless gear changing device is arranged within the hub. Optionally, the wireless gear changing device is sealed within the hub. The wireless gear changing device can be configured to change a hub transmission of the hub. The hub transmission can selectively change a transmission ratio between a driver of the hub (e.g. of a sprocket or cassette connected thereto) and a rim connected to the hub (e.g. via spokes).

Optionally, the wireless gear changing device is configured to be arranged within a crank unit for a bicycle. The wireless gear changing device can be configured to change a crank transmission of the crank unit. The crank transmission can selectively change a transmission ratio between a crank shaft of the crank unit (e.g. of pedals thereto) and a chain ring or belt pulley of the crank unit.

Optionally, the wireless gear control device is configured to be mounted to a handlebar for a bicycle.

Optionally, the user action comprises changing a magnetic field in the at least one of the wireless devices to cause the at least one of the wireless devices to attempt to participate in a pairing process. Changing the magnetic field can e.g. include positioning a magnetic element close to the wireless device. Sensing the presence of the magnetic element by the wireless device can cause the wireless devices to attempt to participate in a pairing process. Sensing the presence of the magnetic element can e.g. be performed using a hall sensor or reed switch.

Optionally, the user action comprises manually operating the wireless gear control device to cause the wireless gear control device to attempt to participate in a pairing process. Optionally, manually operating the wireless gear control device comprises providing a temporal sequence of user inputs to the wireless gear control device. Optionally, the temporal sequence of user inputs to the wireless gear control device corresponds to a, e.g. predetermined, sequence of gear upshifting and/or downshifting indications, in particular while the wireless gear control device is not paired with a wireless gear changing device.

Optionally, manually operating the wireless gear control device comprises contemporaneously providing multiple user inputs to the wireless gear control device.

Optionally, the pairing process involves direct wireless communication between the wireless devices. Alternatively, the pairing process may be independent from any direct wireless communication between the wireless devices.

Optionally, the pairing process, at least the attempt to participate therein, involves wireless communication between at least one of the wireless devices and a mediator device, the mediator device in particular being in the form of a mobile device and/or a wearable device. The wireless communication between on the one hand the wireless gear control device and the wireless gear changing device and on the other hand the mediator device can e.g. comprise NFC, RFID, Bluetooth, Bluetooth Low Energy (BTLE), ANT, ANT+, Zigbee, 6LoWPAN, Thread, WiFi, WiFi-ah, or the like, such as 2.4 GHz communication. Optionally, information stored or received by the mediator device is used in the pairing process by the at least one of the wireless devices, at least in the attempt to participate therein.

Optionally, the pairing process involves determining a device identification of at least one of the wireless devices by a mediator device, the mediator device in particular being in the form of a mobile device and/or a wearable device. The device identification can e.g. be obtained from a machine readable indicator on the wireless device, such as a serial number, QR code, bar code, RF identifier or the like, to be read by the mediator device.

Optionally, the user action comprises adjusting an orientation of the at least one of the wireless devices to cause the respective wireless device to attempt to participate in a pairing process. Optionally, the adjusting of the orientation comprises a temporal sequence of orientation adjustments.

Optionally, the user action comprises shaking the at least one of the wireless devices to cause the respective wireless device to attempt to participate in a pairing process.

Optionally, the wireless gear changing device is, at least during use, associated with at least one of a set of mutually rotatable parts for the bicycle, wherein the user action comprises causing at least one rotation among the mutually rotatable parts to cause the wireless gear changing device to attempt to participate in a pairing process. Optionally, the at least one rotation comprises a temporal sequence of rotations.

Optionally, the user action comprises switching a power supply for the at least one of the wireless devices to cause the respective wireless device to attempt to participate in a pairing process. Optionally, the switching comprises a temporal switching sequence.

Optionally, the user action comprises changing a light level at the at least one of the wireless devices. Optionally, the changing of the light level comprises a temporal sequence of light level changes.

Optionally, the user action involves a key for a lock for the bicycle.

Optionally, the user action involves a tool for assembly and/or adjustment of the bicycle.

Optionally, the user action comprises positioning and/or moving a thru-axle with respect to at least one of the wireless devices, in particular a wireless gear changing device arranged within a hub for a wheel of the bicycle. Thereto, either or both of the thru-axle and the wireless device may comprise a switch and/or a magnet and/or an NFC unit (e.g. NFC tag, NFC interrogator) and/or a machine readable code (e.g. barcode, QR code, color code, or the like) or code reader, for example.

Optionally, the positioning and/or moving of the thru-axles comprises inserting the thru-axle in a hub for a bicycle wheel, such as in a hollow axle thereof, in which hub the wireless device is arranged.

Optionally, the positioning and/or moving of the thru-axle comprises removing the thru-axle from a hub for a bicycle wheel, such as from a hollow axle thereof, in which hub the wireless device is arranged.

Optionally, the positioning and/or moving of the thru-axle causes information stored in or on the thru-axle to be used in the pairing process, at least in the attempt to participate therein. For example, such information may be stored in an NFC tag arranged on or in the thru-axle to be received by the wireless device via a respective NFC interrogator. Advantageously, in this way, such information may be transferred from the thru-axle without the need for a power source such as a battery to be physically connected to the thru-axle.

Optionally, the information is wirelessly transferred from the thru-axle, in particular in response to a wireless power transfer to the thru-axle.

Optionally, the user action is performed to only one of the wireless devices, wherein the pairing process is completed without dependence on any user action to the other of the wireless devices.

Optionally, the user action is performed to at least two of the wireless devices.

A further aspect provides a wireless gear changing system for a bicycle. The system comprises: a wireless gear control device comprising a respective wireless communication unit and configured to send a gear change message via its wireless communication unit; and a wireless gear changing device comprising a respective wireless communication unit and configured to effect a gear change in a bicycle depending on a gear change message received via its wireless communication unit. At least one of the wireless devices is configured to attempt to participate in a pairing process in which the wireless devices can be mutually paired in response to a user action to the at least one of the wireless devices, wherein the system is configured to allow the pairing process to be completed so as to mutually pair the wireless devices.

Preferably, the system is configured for use in a method as described herein.

Optionally, the wireless gear control device comprises at least one user input member configured to be manually operated by the user as part of the user action, wherein the wireless gear control device is configured to allow said at least one user input member to be assigned a different user input function after completion of the user action and/or the pairing process.

Optionally, the system further comprises the mediator device.

Optionally, at least one of the wireless devices is configured to be un-paired and/or re-paired, in particular by a user action to at least one of the wireless devices and/or using a mediator device suitable for communication with at least one of the wireless devices.

A further aspect provides a wireless gear control device for use as the wireless input device of the system as described herein.

A further aspect provides a wireless gear changing device for use as the wireless gear changing device of the system as described herein.

A further aspect provides a method of mutually pairing a wireless gear control device on the one hand and a plurality of mutually exchangeable wireless gear changing devices for a bicycle on the other hand. The method comprises providing a wireless gear control device and a plurality of mutually exchangeable wireless gear changing devices for a bicycle, wherein each wireless device comprises a respective wireless communication unit. The wireless gear changing devices are each configured to effect a gear change in a bicycle depending on a gear change message received via its wireless communication unit when mounted to the bicycle. The wireless gear control device is configured to send a gear change message via its wireless communication unit. Preferably, at any moment only one mutually exchangeable wireless gear changing device of the plurality of mutually exchangeable wireless gear changing devices is operative in the bicycle. The method includes by a user action to at least one of the wireless devices, causing the wireless gear control device and the plurality of wireless gear changing devices to participate in a pairing process in which the wireless gear control device on the one hand and the plurality of the wireless gear changing devices on the other hand are mutually paired; and completing the pairing process so as to complete the pairing of the wireless devices.

A further aspect provides a method of mutually pairing a wireless gear control device and one of a plurality of exchangeable wireless gear changing devices for a bicycle. Preferably, at any moment only one exchangeable wireless gear changing device of the plurality of exchangeable wireless gear changing devices is operative in the bicycle. The method comprises providing a wireless gear control device and a plurality of mutually exchangeable wireless gear changing devices for a bicycle, wherein each wireless device comprises a respective wireless communication unit. The wireless gear changing devices are each configured to effect a gear change in a bicycle depending on a gear change message received via its wireless communication unit. The wireless gear control device is configured to send a gear change message via its wireless communication unit and the wireless gear control device stores an identification of each of the wireless gear changing devices of the plurality of exchangeable wireless gear changing devices. The method includes causing the wireless gear control device to participate in a pairing process with one of the exchangeable wireless gear changing devices of which the identification is stored; and completing the pairing process so as to mutually pair the wireless gear control device and the one of the exchangeable wireless gear changing devices.

A further aspect provides a method of mutually pairing a wireless gear control device and a wireless gear changing device for a bicycle The method comprises providing a wireless gear control device and a wireless gear changing device for a bicycle, wherein each wireless device comprises a respective wireless communication unit; providing a mediator device; and mutually pairing the wireless gear control device and the wireless gear changing device using the mediator device, preferably via wireless communications with each wireless device using the mediator device. The mediator device can e.g. store an identification of the wireless gear control device and the wireless gear changing device and cause pairing of the wireless gear control device and the wireless gear changing device on the basis of the identifications. The identification can be obtained from the wireless gear control device and/or wireless gear changing device using wireless communication. The identification can be obtained from the wireless gear control device and/or wireless gear changing device by user input or by obtaining a machine readable indicator using the mediator device. The mediator device can send a pairing instruction to the wireless gear control device and/or the wireless gear changing device, e.g. via direct wireless communication with the wireless gear control device and/or the wireless gear changing device. The mediator device can send a pairing instruction to the wireless gear control device and/or the wireless gear changing device, e.g. via a communications network, such as the internet, e.g. using 2G, 3G, 4G or 5G. Hence, mutual pairing of the wireless gear control device and the wireless gear changing device can be obtained.

A further aspect provides a method of mutually pairing a wireless gear control device and a selected wireless gear changing device of a plurality of mutually exchangeable wireless gear changing devices for a bicycle Preferably, at any moment only one mutually exchangeable wireless gear changing device of the plurality of mutually exchangeable wireless gear changing devices is operative in the bicycle. The method comprises providing a wireless gear control device and a plurality of mutually exchangeable wireless gear changing devices for a bicycle, wherein each wireless device comprises a respective wireless communication unit; providing a mediator device; and mutually pairing the wireless gear control device and the selected wireless gear changing device of the plurality of wireless gear changing devices using the mediator device, preferably via wireless communications with each wireless device using the mediator device. The mediator device can e.g. store an identification of the wireless gear control device and the plurality of wireless gear changing devices and cause pairing of the wireless gear control device and the selected wireless gear changing device on the basis of the identifications. The identification can be obtained from the wireless gear control device and/or wireless gear changing devices using wireless communication. The identification can be obtained from the wireless gear control device and/or wireless gear changing devices by user input or by obtaining a machine readable indicator using the mediator device. The mediator device can send a pairing instruction to the wireless gear control device and/or the selected wireless gear changing device, e.g. via direct wireless communication with the wireless gear control device and/or the selected wireless gear changing device. The mediator device can send a pairing instruction to the wireless gear control device and/or the selected wireless gear changing device, e.g. via a communications network, such as the internet. Hence, mutual pairing of the wireless gear control device and the selected wireless gear changing device can be obtained. It will be clear that as the mediator device stores the identification of the plurality of exchangeable wireless gear changing devices, when exchanging a first exchangeable wireless gear changing device of the plurality by a second exchangeable wireless gear changing device of the plurality, the mediator device can be used for simply pairing the second exchangeable wireless gear changing device to the wireless gear control device. This can e.g. be advantageous in case of a kit comprising a bicycle having a wireless gear control device and a plurality of exchangeable wheels each having a hub transmission with a wireless gear changing device, for mounting and operating a selected wheel in the bicycle.

A further aspect provides a method of mutually pairing a selected wireless gear control device of a plurality of wireless gear control devices and a wireless gear changing device for a bicycle. Preferably, at any moment only one wireless gear control device of the plurality of wireless gear control devices is operative in the bicycle. The method comprises providing a plurality of wireless gear control devices and a wireless gear changing device for a bicycle, wherein each wireless device comprises a respective wireless communication unit; providing a mediator device; and mutually pairing the selected wireless gear control device of the plurality of wireless gear control devices and the wireless gear changing device using the mediator device, preferably via wireless communications with each wireless device caused using the mediator device. The mediator device can e.g. store an identification of the plurality of wireless gear control devices and the wireless gear changing device and cause pairing of the selected wireless gear control device and the wireless gear changing device on the basis of the identifications. The identification can be obtained from the wireless gear control devices and/or wireless gear changing device using wireless communication. The identification can be obtained from the wireless gear control devices and/or wireless gear changing device by user input or by obtaining a machine readable indicator using the mediator device. The mediator device can send a pairing instruction to the selected wireless gear control device and/or the wireless gear changing device, e.g. via direct wireless communication with the selected wireless gear control device and/or the wireless gear changing device. The mediator device can send a pairing instruction to the selected wireless gear control device and/or the wireless gear changing device, e.g. via a communications network, such as the internet. Hence, mutual pairing of the selected wireless gear control device and the wireless gear changing device can be obtained. It will be clear that as the mediator device stores the identification of the plurality of exchangeable wireless gear control devices, when exchanging a first exchangeable wireless gear control device of the plurality by a second exchangeable wireless gear control device of the plurality, the mediator device can be used for simply pairing the second exchangeable wireless gear control device to the wireless gear changing device. This can e.g. be advantageous in case of a set comprising a plurality of bicycles each having a wireless gear control device and an exchangeable wheel having a hub transmission with a wireless gear changing device, for mounting and operating the wheel in a selected one of the bicycles.

A further aspect provides a method of mutually pairing a selected wireless gear control device of a plurality of wireless gear control devices on the one hand and a selected wireless gear changing device of a plurality of mutually exchangeable gear changing devices for a bicycle on the other hand. Preferably, at any moment only one wireless gear changing device of the plurality of wireless gear control devices is operative in any one bicycle. The method comprises providing a plurality of wireless gear control devices and a plurality of wireless gear changing devices for a bicycle, wherein each wireless device comprises a respective wireless communication unit; providing a mediator device; and mutually pairing the selected wireless gear control device of the plurality of wireless gear control devices and the selected wireless gear changing device of the plurality of wireless gear changing devices using the mediator device, preferably via wireless communications with each wireless device using the mediator device. The mediator device can e.g. store an identification of the plurality of wireless gear control devices and the plurality of wireless gear changing devices and cause pairing of the selected wireless gear control device and the selected wireless gear changing device on the basis of the identifications. The identification can be obtained from the wireless gear control devices and/or wireless gear changing devices using wireless communication. The identification can be obtained from the wireless gear control devices and/or wireless gear changing devices by user input or by obtaining a machine readable indicator using the mediator device. The mediator device can send a pairing instruction to the selected wireless gear control device and/or the selected wireless gear changing device, e.g. via direct wireless communication with the selected wireless gear control device and/or the selected wireless gear changing device. The mediator device can send a pairing instruction to the selected wireless gear control device and/or the selected wireless gear changing device, e.g. via a communications network, such as the internet. Hence, mutual pairing of the selected wireless gear control device and the selected wireless gear changing device can be obtained. It will be clear that as the mediator device stores the identification of the plurality of exchangeable wireless gear control devices and the plurality of exchangeable wireless gear changing devices, the mediator device can be used for simply pairing any exchangeable wireless gear control device of the plurality of exchangeable wireless gear control devices with any exchangeable wireless gear changing device of the plurality of exchangeable wireless gear changing devices. This can e.g. be advantageous in case of a collection comprising a plurality of bicycles each having a wireless gear control device and a plurality of exchangeable wheels each having a hub transmission with a wireless gear changing device, for mounting and operating any selected wheel of the plurality of wheels in any bicycle of the plurality of bicycles. Hence, exchanging wheels and/or bicycles can be performed simply.

It shall be appreciated that aspects and options disclosed herein may be variously combined. For example, features described as relating to a method may be correspondingly applied to a device and/or a system, and vice versa. Wireless gear changing devices as described herein are preferably configured to be arranged within a hub for a wheel of the bicycle, in particular to effect a gear change from within said hub. Still, in some embodiments, one or more of the wireless gear changing devices may be configured differently, e.g. to effect a gear change from outside such a hub.

### DETAILED DESCRIPTION

In the following, the invention will be explained further using examples of embodiments and drawings. The drawings are schematic and merely show examples. In the drawings, corresponding elements have been provided with corresponding reference signs. In the drawings:

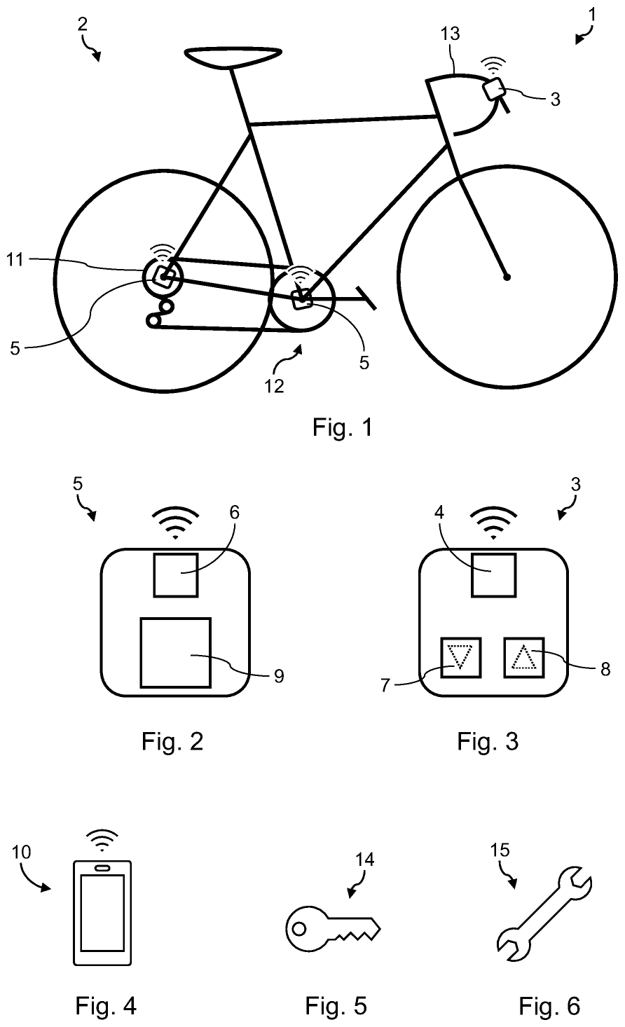

FIG. 1 shows an example of a bicycle provided with a wireless gear changing system;

FIG. 2 shows an example of a wireless gear changing device;

FIG. 3 shows an example of a wireless gear control device;

FIG. 4 shows an example of a mediator device;

FIG. 5 shows an example of a key;

FIG. 6 shows an example of a tool;

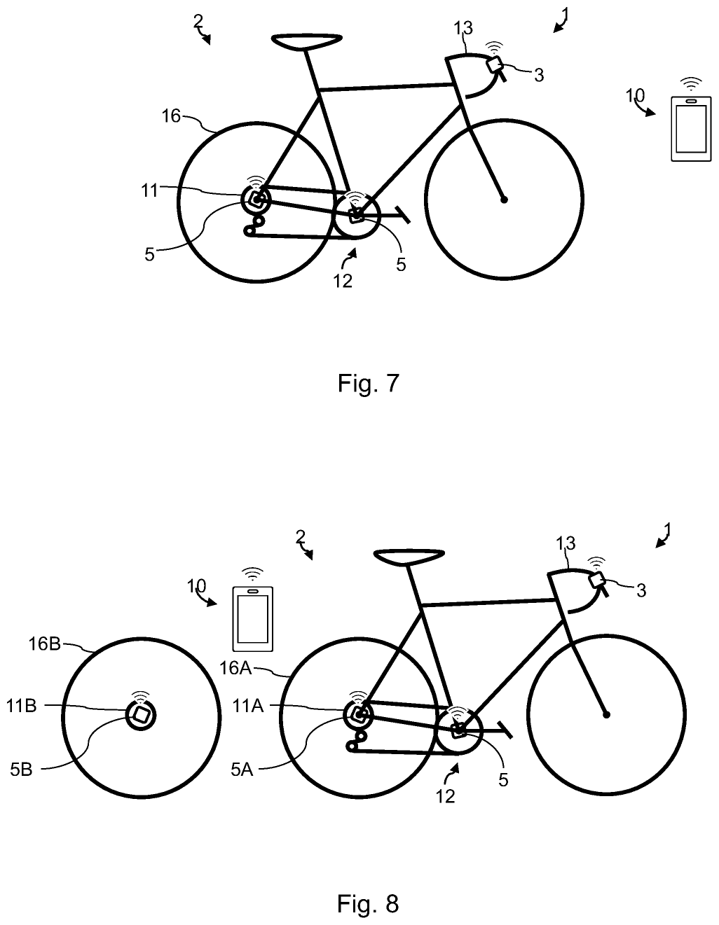

FIG. 7 shows an example of a system;

FIG. 8 shows an example of a system;

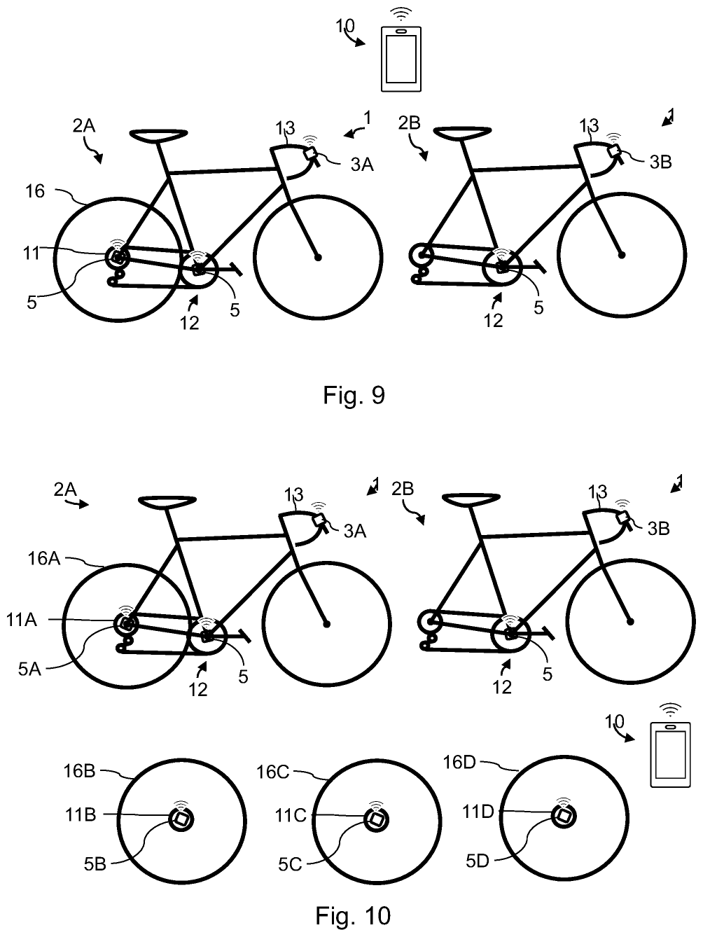

FIG. 9 shows an example of a system;

FIG. 10 shows an example of a system.

FIG. 1 shows an example of a wireless gear changing system 1 for a bicycle 2. The system 1 comprises: a wireless gear control device 3 comprising a respective wireless communication unit 4 and configured to send a gear change message via its wireless communication unit 4; and a wireless gear changing device 5 comprising a respective wireless communication unit 6 and configured to effect a gear change in a bicycle 2 depending on a gear change message received via its wireless communication unit 6. At least one of the wireless devices 3, 5 is configured to attempt to participate in a pairing process in which the wireless devices 3, 5 can be mutually paired in response to a user action to the at least one of the wireless devices 3, 5, wherein the system 1 is configured to allow the pairing process to be completed so as to mutually pair the wireless devices 3, 5.

Optionally, the wireless gear control device 3 comprises at least one, here two, user input member 7, 8 configured to be manually operated by the user as part of the user action. The wireless gear control device 3 may be configured to allow said at least one user input member 7, 8 to be assigned a different user input function, e.g. a gear change indication function, after completion of the user action and/or the pairing process.

Optionally, the wireless gear change device 5 comprises a gear change actuator 9, e.g. a motor, for effecting the gear change.

Optionally, at least one of the wireless devices 3, 5 is configured to be un-paired and/or re-paired, in particular by a user action to at least one of the wireless devices 3, 5 and/or using a mediator device 10 suitable for communication with at least one of the wireless devices 3, 5. Optionally, the system 1 further comprises such a mediator device 10, e.g. a mobile device, such as a smartphone, and/or wearable device.

Preferably, the system 1 is configured for use in a method as described herein.

The figures variously illustrate a method of mutually pairing a wireless gear control device 3 and a wireless gear changing device 5 for a bicycle 1. The method comprises providing a wireless gear control device 3 and a wireless gear changing device 5 for a bicycle 2, wherein both wireless devices 3, 5 comprise a respective wireless communication unit 4, 6. The wireless gear changing device 5 is configured to effect a gear change in a bicycle 2, at least when mounted to the bicycle 2, depending on a gear change message received via its wireless communication unit 6, e.g. using a respective actuator 9. The wireless gear control device 3 is configured to send a gear change message via its wireless communication unit 4, e.g. in response to a user input received via a user input member 7 and/or 8.

The method further comprises by a user action to at least one of the wireless devices 3, 5, causing the at least one of the wireless devices 3, 5 to attempt to participate in a pairing process in which the wireless devices 3, 5 can be mutually paired, and completing the pairing process so as to mutually pair the wireless devices 3, 5.

In this example, the wireless gear changing device 5 is configured to be arranged within a hub 11 for a bicycle wheel. Here, the wireless gear changing device 5 is arranged within the hub 11. Here, the wireless gear changing device 5 is sealed within the hub 11. The wireless gear changing device can be configured to change a hub transmission of the hub. The hub transmission can selectively change a transmission ratio between a driver of the hub (e.g. of a sprocket or cassette connected thereto) and a rim connected to the hub (e.g. via spokes). Here, the hub 11 is connected to a frame of the bicycle by a thru-axle. Here, the thru-axle is inserted through a hollow axle of the hub. The thru-axle may for example be provided with a machine readable code containing information to be used in the pairing process, in particular to be read by a code reader of the wireless gear changing device 5 e.g. when the thru-axle is inserted in the hub 11 housing the wireless gear changing device 5. In particular, the thru-axle may for example be provided with an NFC tag storing information to be used in the pairing process, in particular to be read by an optional NFC interrogator of the wireless gear changing device 5 e.g. when the thru-axle is inserted in the hub 11 housing the wireless gear changing device 5.

Alternatively, the wireless gear changing device 5 can be configured to be arranged within a crank unit 12 for a bicycle. The wireless gear changing device can be configured to change a crank transmission of the crank unit. The crank transmission can selectively change a transmission ratio between a crank shaft of the crank unit (e.g. of pedals thereto) and a chain ring or belt pulley of the crank unit.

In this example, the wireless gear control device 3 is configured to be mounted to a handlebar 13 for a bicycle.

In an example, the user action comprises changing a magnetic field in the at least one of the wireless devices 3, 5 to cause the at least one of the wireless devices 3, 5 to attempt to participate in a pairing process. Such a magnetic field change may for example be effected by a user by moving a magnet with respect to the wireless device, e.g. towards and/or away from the device, and/or by switching an electromagnet in the vicinity of the device. To be able to detect such a magnetic field change, the wireless device may be provided with a corresponding sensor, e.g. an induction coil and/or a reed switch.

Optionally, the user action comprises manually operating the wireless gear control device 3 to cause the wireless gear control device 3 to attempt to participate in a pairing process. Optionally, manually operating the wireless gear control device 3 comprises providing a temporal sequence of user inputs to the wireless gear control device 3. Optionally, the temporal sequence of user inputs to the wireless gear control device 3 corresponds to a sequence of gear upshifting and/or downshifting indications, e.g. via respective user input members 7, 8, in particular while the wireless gear control device 3 is not paired with a wireless gear changing device 5.

Optionally, manually operating the wireless gear control device 3 comprises contemporaneously providing multiple user inputs to the wireless gear control device 3, e.g. via multiple user input members 7, 8 at the same time.

Optionally, the pairing process involves direct wireless communication between the wireless devices 3, 5. Alternatively, the pairing process may be independent from such direct wireless communication between the wireless devices 3, 5.

Optionally, the pairing process involves wireless communication between at least one of the wireless devices 3, 5 and a mediator device 10, the mediator device 10 in particular being in the form of a mobile device and/or a wearable device. Optionally, the pairing process involves determining a device identification of at least one of the wireless devices by a mediator device, the mediator device in particular being in the form of a mobile device and/or a wearable device. The pairing process can e.g. include obtaining a device identification of the wireless gear control device 3 and obtaining a device identification of the wireless gear changing device 5 with the mediator device. The device identification can e.g. be obtained from a machine readable indicator on the wireless device, such as a serial number, QR code, bar code, RF identifier or the like, read by the mediator device. The mediator device can send a pairing instruction to the wireless gear control device 3 and/or the wireless gear changing device 5, e.g. via direct wireless communication with the wireless gear control device 3 and/or the wireless gear changing device 5. The mediator device can send a pairing instruction to the wireless gear control device 3 and/or the wireless gear changing device 5, e.g. via a communications network, such as the internet. Hence, mutual pairing of the wireless gear control device and the wireless gear changing device can be obtained. Hence, wireless communication between the mediator device and the wireless devices 3, 5 may be omitted. In response to receiving the pairing instruction, the wireless gear control device 3 and/or the wireless gear changing device 5 attempts to participate in a pairing process in which the wireless devices 3, 5 can be mutually paired. The pairing process can then be completed so as to mutually pair the wireless devices.

Optionally, the user action comprises adjusting an orientation of the at least one of the wireless devices 3, 5 to cause the respective wireless device to attempt to participate in a pairing process. Optionally, the adjusting of the orientation comprises a temporal sequence of orientation adjustments. To be able to detect such an orientation change, the respective wireless device may be provided with a corresponding sensor, e.g. an accelerometer and/or a gyroscope.

Optionally, the user action comprises shaking the at least one of the wireless devices 3, 5 to cause the respective wireless device to attempt to participate in a pairing process. To be able to detect such a shaking, the respective wireless device may be provided with a corresponding sensor, e.g. an accelerometer and/or a gyroscope.

Optionally, the wireless gear changing device 5 is, at least during use, associated with at least one of a set of mutually rotatable parts for the bicycle 2, the parts e.g. being comprised by a transmission and/or a wheel of the bicycle 2, wherein the user action comprises causing at least one rotation among the mutually rotatable parts to cause the wireless gear changing device 5 to attempt to participate in a pairing process. Optionally, the at least one rotation comprises a temporal sequence of rotations. To be able to detect such a rotation, the wireless gear changing device 5 may be provided with a corresponding sensor, e.g. a rotary encoder.

Optionally, the user action comprises switching a power supply, e.g. from a battery, for the at least one of the wireless devices 3, 5 to cause the respective wireless device to attempt to participate in a pairing process. Optionally, the switching comprises a temporal switching sequence. To be able to detect such a switching, the respective device may be configured to detect a corresponding power level variation, wherein for example a capacitor may be provided to allow the device to continue to operate during the switching. Alternatively or additionally, the device may automatically log events such as a booting event associated with a switching on of a power supply, wherein the device may then infer a relevant switching sequence from time stamps of the logged events.

Optionally, the user action comprises changing a light level at the at least one of the wireless devices 3, 5. Optionally, the changing of the light level comprises a temporal sequence of light level changes. To be able to detect such a light level change, the respective device may be provided with a corresponding sensor such as a light level sensor.

Optionally, the user action involves a key 14 for a lock for the bicycle 2. Optionally, the user action involves a tool 15 for assembly and/or adjustment of the bicycle 2. Such a key 14 or tool 15 may be configured or at least suitable for use in a user action as described herein. For example, the key or tool may comprise a magnet suitable for causing the magnetic field change as described herein.

A further aspect provides a method of mutually pairing a wireless gear control device 3 on the one hand and a plurality of mutually exchangeable wireless gear changing devices 5 for a bicycle 2 on the other hand, comprising: providing a wireless gear control device 3 and a plurality of mutually exchangeable wireless gear changing devices 5 for a bicycle 2, wherein each wireless device 3, 5 comprises a respective wireless communication unit 4, 6, wherein the wireless gear changing devices 5 are each configured to effect a gear change in a bicycle 2 depending on a gear change message received via its wireless communication unit 6, wherein the wireless gear control device 3 is configured to send a gear change message via its wireless communication unit 4; by a user action to at least one of the wireless devices 3, 5, causing the wireless gear control device 3 and the plurality of wireless gear changing devices 5 to participate in a pairing process in which the wireless gear control device 3 on the one hand and the plurality of the wireless gear changing devices 5 on the other hand are mutually paired; and completing the pairing process so as to complete the pairing of the wireless devices 3, 5.

A further aspect provides a method of mutually pairing a wireless gear control device 3 and one of a plurality of exchangeable wireless gear changing devices 5 for a bicycle 2, comprising: providing a wireless gear control device 3 and a plurality of mutually exchangeable wireless gear changing devices 5 for a bicycle 2, wherein each wireless device 3, 5 comprises a respective wireless communication unit 4, 6, wherein the wireless gear changing devices 5 are each configured to effect a gear change in a bicycle 2 depending on a gear change message received via its wireless communication unit 6, wherein the wireless gear control device 3 is configured to send a gear change message via its wireless communication unit 4 and wherein the wireless gear control device 3 stores an identification of each of the wireless gear changing devices 5 of the plurality of exchangeable wireless gear changing devices 5; causing the wireless gear control device 3 to participate in a pairing process with one of the wireless gear changing devices 5 of which the identification is stored; and completing the pairing process so as to mutually pair the wireless gear control device 3 and the one of the wireless gear changing devices 5.

For instance as exemplified in FIG. 7, a further aspect provides a method of mutually pairing a wireless gear control device 3 and a wireless gear changing device 5 for a bicycle 2, comprising: providing a wireless gear control device 3 and a wireless gear changing device 5 for a bicycle 2, wherein each wireless device 3, 5 comprises a respective wireless communication unit 4, 6; providing a mediator device 10; and mutually pairing the wireless gear control device 3 and the wireless gear changing device 5 using the mediator device 10. In this example, the wireless gear changing device 5 is associated with, here mounted in, a hub 11 of a wheel 16 for a bicycle 2. The mediator device 10 can e.g. store an identification of the wireless gear control device 3 and the wireless gear changing device 5 and cause pairing of the wireless gear control device 3 and the wireless gear changing device 5 on the basis of the identifications. In this example, the identification is obtained from the wireless gear control device 3 and/or wireless gear changing device 5 using wireless communication. Alternatively, or additionally, the identification can be obtained from the wireless gear control device 5 and/or wireless gear changing device 3 by user input or by obtaining a machine readable indicator using the mediator device 10. The mediator device can send a pairing instruction to the wireless gear control device 3 and/or the wireless gear changing device 5, e.g. via direct wireless communication with the wireless gear control device 3 and/or the wireless gear changing device 5. The mediator device can send a pairing instruction to the wireless gear control device 3 and/or the wireless gear changing device 5, e.g. via a communications network, such as the internet. Hence, mutual pairing of the wireless gear control device and the wireless gear changing device can be obtained. Hence, wireless communication between the mediator device and the wireless devices 3, 5 may be omitted. In response to receiving the pairing instruction, the wireless gear control device 3 and/or the wireless gear changing device 5 attempts to participate in a pairing process in which the wireless devices 3, 5 can be mutually paired. The pairing process can then be completed so as to mutually pair the wireless devices. Hence, mutual pairing of the wireless gear control device and the wireless gear changing device can be obtained.

For instance as exemplified in FIG. 8, a further aspect provides a method of mutually pairing a wireless gear control device 3 and a selected wireless gear changing device 5A of a plurality of mutually exchangeable wireless gear changing devices 5A, 5B for a bicycle 2, comprising: providing a wireless gear control device 3 and a plurality of mutually exchangeable wireless gear changing devices 5A, 5B for a bicycle 2, wherein each wireless device 3, 5A, 5B comprises a respective wireless communication unit 4, 6. Here, each wireless gear changing device 5A, 5B is mounted to a respective hub 11A, 11B, more particularly to a respective wheel 16A, 16B. In this example, at any moment only one wireless gear control device 5A, 5B of the plurality of wireless gear control devices 5A, 5B is operative in the bicycle 2. The method includes providing a mediator device 10; and mutually pairing the wireless gear control device 3 and the selected wireless gear changing device 5A of the plurality of wireless gear changing devices 5A, 5B using the mediator device 10. The mediator device 10 can e.g. store an identification of the wireless gear control device 3 and the plurality of wireless gear changing devices 5A, 5B and cause pairing of the wireless gear control device 3 and the selected wireless gear changing device 5A on the basis of the identifications. In this example, the identification is obtained from the wireless gear control device 3 and/or wireless gear changing devices 5A, 5B using wireless communication. Alternatively, or additionally, the identification can be obtained from the wireless gear control device 3 and/or wireless gear changing devices 5A, 5B by user input or by obtaining a machine readable indicator using the mediator device 10. The mediator device 10 can send a pairing instruction to the wireless gear control device 3 and/or the selected wireless gear changing device 5A, e.g. via direct wireless communication with the wireless gear control device 3 and/or the selected wireless gear changing device 5A. The mediator device 10 can send a pairing instruction to the wireless gear control device 3 and/or the selected wireless gear changing device 5A, e.g. via a communications network, such as the internet. Hence, mutual pairing of the wireless gear control device 3 and the selected wireless gear changing device 5A can be obtained. Hence, wireless communication between the mediator device and the wireless devices 3, 5 may be omitted. In response to receiving the pairing instruction, the wireless gear control device 3 and/or the selected wireless gear changing device 5A attempts to participate in a pairing process in which the wireless devices 3, 5A can be mutually paired. The pairing process can then be completed so as to mutually pair the wireless devices. It will be clear that as the mediator device 10 stores the identification of the plurality of exchangeable wireless gear changing devices 5A, 5B, when exchanging a first exchangeable wireless gear changing device 5A of the plurality by a second exchangeable wireless gear changing device of the plurality 5B, e.g. when exchanging the first wheel 16A by the second wheel 16B, the mediator device 10 can be used for simply pairing the second exchangeable wireless gear changing device 5B to the wireless gear control device 3. This can e.g. be advantageous in case of a kit comprising a bicycle having a wireless gear control device 3 and a plurality of exchangeable wheels 16A, 16B each having a hub transmission with a wireless gear changing device 5A, 5B, for mounting and operating a selected wheel in the bicycle 2.

For instance as exemplified in FIG. 9, a further aspect provides a method of mutually pairing a selected wireless gear control device 3A of a plurality of wireless gear control devices 3A, 3B and a wireless gear changing device 5 for a bicycle 2, comprising: providing a plurality of wireless gear control devices 3A, 3B and a wireless gear changing device 5 for a bicycle 2, wherein each wireless device 3A, 3B, 5 comprises a respective wireless communication unit 4, 6. Here, each wireless gear control device 3A, 3B is mounted to a respective bicycle 2A, 2B. The method includes providing a mediator device 10; and mutually pairing the selected wireless gear control device 3 of the plurality of wireless gear control devices 3 and the wireless gear changing device 5 using the mediator device 10. The mediator device 10 can e.g. store an identification of the plurality of wireless gear control devices 3A, 3B and the wireless gear changing device 5 and cause pairing of the selected wireless gear control device 3A and the wireless gear changing device 5 on the basis of the identifications. In this example, the identification can be obtained from the wireless gear control devices 3A, 3B and/or wireless gear changing device 5 using wireless communication. Alternatively, or additionally, the identification can be obtained from the wireless gear control devices 3A, 3B and/or wireless gear changing device 5 by user input or by obtaining a machine readable indicator using the mediator device. The mediator device 10 can send a pairing instruction to the selected wireless gear control device 3A and/or the wireless gear changing device 5, e.g. via direct wireless communication with the selected wireless gear control device 3A and/or the wireless gear changing device 5. The mediator device 10 can send a pairing instruction to the selected wireless gear control device 3A and/or the wireless gear changing device 5, e.g. via a communications network, such as the internet. Hence, mutual pairing of the selected wireless gear control device 3A and the wireless gear changing device 5 can be obtained. Hence, wireless communication between the mediator device and the wireless devices 3, 5 may be omitted. In response to receiving the pairing instruction, the selected wireless gear control device 3A and/or the wireless gear changing device 5 attempts to participate in a pairing process in which the wireless devices 3A, 5 can be mutually paired. The pairing process can then be completed so as to mutually pair the wireless devices. It will be clear that as the mediator device stores the identification of the plurality of exchangeable wireless gear control devices 3A, 3B, when exchanging a first exchangeable wireless gear control device 3A of the plurality by a second exchangeable wireless gear control device 3B of the plurality, the mediator device 10 can be used for simply pairing the second exchangeable wireless gear control device 3B to the wireless gear changing device 5. This can e.g. be advantageous in case of a set comprising a plurality of bicycles 2A, 2B each having a wireless gear control device 3A, 3B and an exchangeable wheel 16 having a hub transmission with a wireless gear changing device 5, for mounting and operating the wheel in a selected one of the bicycles.

For instance as exemplified in FIG. 10, a further aspect provides a method of mutually pairing a selected wireless gear control device 3A of a plurality of wireless gear control devices 3A, 3B on the one hand and a selected wireless gear changing device 5A of a plurality of mutually exchangeable gear changing devices 5A, 5B, 5C, 5D for a bicycle 2 on the other hand, comprising: providing a plurality of wireless gear control devices 3A, 3B and a plurality of wireless gear changing devices 5A, 5B, 5C, 5D for a bicycle 2, wherein each wireless device 3, 5 comprises a respective wireless communication unit 4, 6. Preferably, at any moment only one wireless gear changing device of the plurality of wireless gear control devices is operative in any one bicycle. The method includes providing a mediator device 10; and mutually pairing the selected wireless gear control device 3 of the plurality of wireless gear control devices 3 and the selected wireless gear changing device 5 of the plurality of wireless gear changing devices 5 using the mediator device 10. The mediator device 10 can e.g. store an identification of the plurality of wireless gear control devices 3A, 3B and the plurality of wireless gear changing devices 5A, 5B, 5C, 5D and cause pairing of the selected wireless gear control device 3A and the selected wireless gear changing device 5A on the basis of the identifications. In this example, the identification is obtained from the wireless gear control devices 3A, 3B and/or wireless gear changing devices 5A, 5B, 5C. 5D using wireless communication. Alternatively, or additionally, the identification can be obtained from the wireless gear control devices 3A, 3B and/or wireless gear changing devices 5A, 5B, 5C, 5D by user input or by obtaining a machine readable indicator using the mediator device 10. The mediator device 10 can send a pairing instruction to the selected wireless gear control device 3A and/or the selected wireless gear changing device 5A, e.g. via direct wireless communication with the selected wireless gear control device 3A and/or the selected wireless gear changing device 5A. The mediator device 10 can send a pairing instruction to the selected wireless gear control device 3A and/or the selected wireless gear changing device 5A, e.g. via a communications network, such as the internet. Hence, mutual pairing of the selected wireless gear control device 3A and the selected wireless gear changing device 5A can be obtained. In response to receiving the pairing instruction, the selected wireless gear control device 3A and/or the selected wireless gear changing device 5A attempts to participate in a pairing process in which the wireless devices 3A, 5A can be mutually paired. The pairing process can then be completed so as to mutually pair the wireless devices. It will be clear that as the mediator device 10 stores the identification of the plurality of exchangeable wireless gear control devices 3A, 3B and the plurality of exchangeable wireless gear changing devices 5A, 5B, 5C, 5D, the mediator device 10 can be used for simply pairing any exchangeable wireless gear control device of the plurality of exchangeable wireless gear control devices with any exchangeable wireless gear changing device of the plurality of exchangeable wireless gear changing devices. This can e.g. be advantageous in case of a collection comprising a plurality of bicycles 2A, 2B each having a wireless gear control device 3A, 3B and a plurality of exchangeable wheels 16A, 16B, 16C, 16D each having a hub transmission with a wireless gear changing device 5A, 5B, 5C, 5D, for mounting and operating any selected wheel of the plurality of wheels in any bicycle of the plurality of bicycles. Hence, exchanging wheels and/or bicycles can be performed simply.

Although the invention has been explained further herein using examples of embodiments and drawings, these do not limit the scope of the invention as defined by the claims. Within said scope, many variations, combinations and extensions are possible, as will be appreciated by the skilled person. For example, a wireless gear control device may be configured to send a gear change message partly or fully automatically, i.e. partly or fully independent from any active user input, for example in response to a sensor input such as from a sensor associated with the bicycle, e.g. a speed sensor or a torque sensor, and/or from a sensor associated with a rider of the bicycle, e.g. a heart rate sensor or a temperature sensor. Further, wireless devices may be mutually pre-paired, e.g. during production, while still allowing a user to adjust such pairing, e.g. by an un-pairing or a re-pairing.

1. A method of mutually pairing a wireless gear control device and a wireless gear changing device for a bicycle, comprising:
providing a wireless gear control device and a wireless gear changing device for a bicycle, wherein both wireless devices comprise a respective wireless communication unit,
wherein the wireless gear changing device is configured to effect a gear change in a bicycle depending on a gear change message received via its wireless communication unit,
wherein the wireless gear control device is configured to send at least a gear change message via its wireless communication unit;
by a user action to at least one of the wireless device, causing at least one of the wireless devices to attempt to participate in a pairing process in which the wireless devices can be mutually paired; and
completing the pairing process so as to mutually pair the wireless devices.

2. The method according to claim 1, wherein the wireless gear changing device is arranged within a hub for a bicycle wheel.

3. (canceled)

4. The method according to claim 2, wherein the wireless gear changing device is sealed within the hub.

5. The method according to claim 1, wherein the wireless gear changing device is configured to be arranged within a crank unit for a bicycle.

6. The method according to claim 1, wherein the wireless gear control device is configured to be mounted to a handlebar for a bicycle.

7. The method according to claim 1, wherein the user action comprises changing a magnetic field in the at least one of the wireless devices to cause the at least one of the wireless devices to attempt to participate in a pairing process.

8. The method according to claim 1, wherein the user action comprises manually operating the wireless gear control device to cause the wireless gear control device to attempt to participate in a pairing process.

9. The method according to claim 8, wherein manually operating the wireless gear control device comprises providing a temporal sequence of user inputs to the wireless gear control device.

10. The method according to claim 9, wherein the temporal sequence of user inputs to the wireless gear control device corresponds to a sequence of gear upshifting and/or downshifting indications, while the wireless gear control device is not paired with a wireless gear changing device.

11. The method according to claim 8, wherein manually operating the wireless gear control device comprises contemporaneously providing multiple user inputs to the wireless gear control device.

12. The method according to claim 1, wherein the pairing process involves direct wireless communication between the wireless devices.

13. The method according to claim 1, wherein the pairing process is independent from any direct wireless communication between the wireless devices.

14. The method according to claim 1, wherein the pairing process, at least the attempt to participate therein, involves wireless communication between at least one of the wireless devices and a mediator device, the mediator device being in the form of a mobile device and/or a wearable device, wherein optionally information stored or received by the mediator device is used in the pairing process by the at least one of the wireless devices, at least in the attempt to participate therein.

15. The method according to claim 1, wherein the user action comprises adjusting an orientation of the at least one of the wireless devices to cause the respective wireless device to attempt to participate in a pairing process.

16. The method according to claim 15, wherein the adjusting of the orientation comprises a temporal sequence of orientation adjustments.

17. The method according to claim 1, wherein the user action comprises shaking the at least one of the wireless devices to cause the respective wireless device to attempt to participate in a pairing process.

18. The method according to claim 1, wherein the wireless gear changing device is associated with at least one of a set of mutually rotatable parts for the bicycle, wherein the user action comprises causing at least one rotation among the mutually rotatable parts to cause the wireless gear changing device to attempt to participate in a pairing process.

19. The method according to claim 18, wherein the at least one rotation comprises a temporal sequence of rotations.

20. The method according to claim 1, wherein the user action comprises switching a power supply for the at least one of the wireless devices to cause the respective wireless device to attempt to participate in a pairing process.

21. The method according to claim 20, wherein the switching comprises a temporal switching sequence.

22. The method according to claim 1, wherein the user action comprises changing a light level at the at least one of the wireless devices.

23. The method according to claim 22, wherein the changing of the light level comprises a temporal sequence of light level changes.

24. The method according to claim 1, wherein the user action involves a key for a lock for the bicycle.

25. The method according to claim 1, wherein the user action involves a tool for assembly and/or adjustment of the bicycle.

26. The method according to claim 1, wherein the user action comprises positioning and/or moving a thru-axle with respect to at least one of the wireless devices a wireless gear changing device arranged within a hub for a wheel of the bicycle.

27. The method according to claim 26, wherein the positioning and/or moving of the thru-axles comprises inserting the thru-axle in a hub for a bicycle wheel, such as in a hollow axle thereof, in which hub the wireless device is arranged.

28. The method according to claim 26, wherein the positioning and/or moving of the thru-axle comprises removing the thru-axle from a hub for a bicycle wheel, such as from a hollow axle thereof, in which hub the wireless device is arranged.

29. The method according to claim 26, wherein the positioning and/or moving of the thru-axle causes information stored in or on the thru-axle to be used in the pairing process, at least in the attempt to participate therein.

30. The method according to claim 29, wherein the information is wirelessly transferred from the thru-axle in response to a wireless power transfer to the thru-axle.

31. The method according to claim 1, wherein the user action is performed to only one of the wireless devices, wherein the pairing process is completed without dependence on any user action to the other of the wireless devices.

32. The method according to claim 1, wherein the user action is performed to at least two of the wireless devices.

33. A wireless changing system for a bicycle, comprising:
a wireless gear control device comprising a respective wireless communication unit and configured to send a gear change message via its wireless communication unit; and
a wireless gear changing device comprising a respective wireless communication unit and configured to effect a gear change in a bicycle depending on a gear change message received via its wireless communication unit,
wherein at least one of the wireless devices is configured to attempt to participate in a pairing process in which the wireless devices can be mutually paired in response to a user action to the at least one of the wireless devices,
wherein the system is configured to allow the pairing process to be completed so as to mutually pair the wireless devices.

34. (canceled)

35. The wireless changing system according to claim 33, wherein the wireless gear control device comprises at least one user input member configured to be manually operated by the user as part of the user action, wherein the wireless gear control device is configured to allow said at least one user input member to be assigned a different user input function after completion of the user action and/or the pairing process.

36. The wireless changing system according to claim 33, further comprising a mediator device, the mediator device being in the form of a mobile device and/or a wearable device, wherein information stored or received by the mediator device is used in the pairing process by the at least one of the wireless devices, at least in the attempt to participate therein.

37. The wireless changing system according to claim 33, wherein at least one of the wireless devices is configured to be un-paired and/or re-paired by a user action to at least one of the wireless devices and/or using a mediator device.

38.-40. (canceled)

41. A method of mutually pairing a wireless gear control device and one of a plurality of mutually exchangeable wireless gear changing devices for a bicycle, comprising:
providing the wireless gear control device and the plurality of mutually exchangeable wireless gear changing devices for the bicycle, wherein each wireless device comprises a respective wireless communication unit,
wherein the plurality of mutually exchangeable wireless gear changing devices are each configured to effect a gear change in the bicycle depending on a gear change message received via its wireless communication unit,
wherein the wireless gear control device is configured to send a gear change message via its wireless communication unit and wherein the wireless gear control device stores an identification of each of the wireless gear changing devices of the plurality of mutually exchangeable wireless gear changing devices,
wherein each of the plurality of mutually exchangeable wireless gear changing devices is configured to be arranged within a hub for a wheel of the bicycle;
causing the wireless gear control device to participate in a pairing process with one of the plurality of mutually exchangeable wireless gear changing devices of which the identification is stored; and
completing the pairing process so as to mutually pair the wireless gear control device and the one of the plurality of mutually exchangeable wireless gear changing devices.

42. A method of mutually pairing a wireless gear control device and a wireless gear changing device for a bicycle, comprising:
providing the wireless gear control device and the wireless gear changing device for the bicycle, wherein each wireless device comprises a respective wireless communication unit, wherein the wireless gear changing device is configured to be arranged within a hub for a wheel of the bicycle;
providing a mediator device; and
mutually pairing the wireless gear control device and the wireless gear changing device using the mediator device via wireless communications with each wireless device caused using the mediator device.

43.-45. (canceled)
